(19) United States
(12) Patent Application Publication
(10) Pub. No.: US 2011/0233191 A1
(43) Pub. Date: Sep. 29, 2011

(54) ELECTRICAL HEATING ELEMENT

(75) Inventors: Ulrich GUBLER, Rotkreuz/ZG (CH); Simon OTT, Auenstein (CH)

(73) Assignee: LEISTER PROCESS TECHNOLOGIES, Kagiswill (CH)

(21) Appl. No.: 13/071,656

(22) Filed: Mar. 25, 2011

(30) Foreign Application Priority Data
Mar. 25, 2010 (DE) 20 2010 004 133.3

(51) Int. Cl. H05B 3/06

(52) U.S. Cl. 219/546

(57) ABSTRACT

Electrical heating element 1, preferably for the ignition of biomass heating systems such as pellet stoves, with an elongated coil carrier 2 that is made of a thermally resistant, electrically insulating material and is designed to accept a heating wire coil, where the heating wire coil is held spiral-like on the outside the coil carrier 2 and is enclosed by a sleeve tube 4 also made of a thermally resistant material. The coil carrier 2 and the sleeve tube 4 delimit an air channel 5 through which the heating wire coil passes. According to the invention, the coil carrier 2 comprises at least two adjacent coil carrier shell parts 6, 6′ that extend symmetrically to the center axis 8 of the heating element 1 in the longitudinal direction of the coil carrier 2.

### CROSS-REFERENCE TO RELATED APPLICATION

The present application claims priority under 35 USC §119 to German Patent Application No. 20 2010 004 133.3 filed Mar. 25, 2010, the entire disclosure of which is incorporated herein by reference.

### TECHNICAL FIELD OF THE INVENTION

The invention concerns an electrical heating element, preferably for the ignition of a pellet heating system or some other biomass heating system or of related stoves, with an elongated coil carrier made of a thermally resistant, electrically insulating material designed to accept a heating wire coil, where the heating wire coil is held spiral-like on the outside the coil carrier and is enclosed by a sleeve tube made of a thermally resistant material, and where the coil carrier and the sleeve tube delimit an air channel through which the heating wire coil passes.

### DESCRIPTION OF THE RELATED ART

Wood pellet heating systems or other biomass heating systems are an alternative technology for oil and gas heating systems for generating thermal energy. In terms of operation, maintenance, and efficiency, modern central heating systems with wood pellets as a renewable energy source are comparable to oil and gas heating systems using fossil energy sources. In a central wood pellet heating system, the wood pellets that usually come in the shape of small cylindrical rods made of compressed wood material are combusted in a combustion chamber of a heating furnace and the released energy is transferred conventionally to a hot water circulation system by means of a heat exchanger. The wood pellets are conveyed periodically and automatically, as needed, from a pellet storage system to the combustion chamber by means of a conveyor screw or a suction system. For the combustion, conventional combustion chambers are used in wood heating systems. After their introduction into the chamber, the pellets are ignited by means of an electrical heating rod or an electrically operated hot air blower. The wood pellets are then combusted in a controlled manner by means of a controlled air supply, for example by means of electrically controlled ventilators.

Ignition devices for the ignition of solid fuels, in particular for the ignition of renewable fuels like pellets, wood chips, or wood logs or other biomass material such as corn, grain, or similar materials are sufficiently known from prior art. The publication JP 2005/172 383 A, for example, discloses an ignition system for a combustion chamber with pellets where a rod-shaped heating element is arranged concentrically in a guide tube. The guide tube has openings into which air is blown by means of a blower. The air passes between the guide tube and the heating element, is heated, and flows out of an opening at the end of the guide tube. Due to its rod-shaped configuration, the heating element has a relatively large mass that needs to be heated to the ignition temperature when the heating element is switched on. The electrical ignition system, configured as a heating cartridge, conveys the thermal energy generated by the heating element to the fuel pellets by means of hot air.

Besides central pellet heating systems for heating entire buildings, pellet stoves for heating individual rooms have become established on the market for heating systems. In most pellet stoves, the ignition system does not have its own blower for reasons of cost and noise so that the heating element needs to operate with the normal draft air supply of the furnace, i.e. under any prevailing air flow and pressure conditions. The heating element must not self-destruct even if, due to contamination for example, little or no air flows through the heating element. Currently, for ignition systems with their own blower for pellet stoves, heating elements are used that usually comprise a ceramic multi-hole tube with a heating wire coil. Conventional arrangements of the coils in the multi-hole tube are not sufficient for operation under all prevailing air flows and pressure conditions. In addition, the labor required for manufacturing the heating element with a heating wire coil guided through the air channels of the multi-hole tube is costly. In ignition systems without blower, a heating cartridge is usually used instead, as described for example in the patent application JP 2005/172 383 A referred to above, with a sleeve made of steel or similar material.

### SUMMARY OF THE INVENTION

The invention addresses the problem of proposing an electrical heating element that is of technologically simpler construction and can therefore be produced more cost-efficiently, and that also operates without problems over the long term, independent of the air conditions.

According to the invention, this problem is solved by an electrical heating element with the characteristics of claim 1. Additional advantageous embodiments are given in the related claims.

The coil carrier according to the invention comprises at least two adjacent coil carrier shell parts that extend symmetrically to the center axis of the heating element in the longitudinal direction of the coil carrier. Preferably, the coil carrier shell parts are of identical design and can therefore be produced and processed in a cost-efficient way.

Like the coil carrier, the coil carrier shell parts have an elongated shape and are made as separate components. In the assembled condition, the coil carrier shell parts form the coil carrier that carries the heating wire coil. Ceramic material is the preferred material for the coil carrier shell parts that are thermally resistant and electrically insulating in sintered condition. The heating wire coil comprises a resistance wire with at least one coiled central longitudinal section and, at the ends of the coiled longitudinal section, preferably two straight, i.e. non-coiled longitudinal sections. The coiled longitudinal sections serve as heating segments, the non-coiled longitudinal sections serve as connection segments. The heating wire coil is held in a spiral shape on the outside of the coil carrier and is enclosed by a sleeve tube made of any type of thermally resistant material. Preferably, the sleeve tube is a mica tube or a ceramic tube.

The coil carrier and the sleeve tube delimit an air channel through which the heating wire coil passes, with at least the coiled central longitudinal section of the heating wire coil extending inside the air channel. In principle, the coil carrier may be composed of two, three, four, or more coil carrier shell parts. It proved to be especially advantageous for the manufacture and the related manufacturing costs of the electrical heating element according to the invention if the coil carrier shell parts are designed with identical geometry and as coil carrier half shells.

In a preferred embodiment of the invention, the at least two coil carrier shell parts comprise at least at their two ends sleeve tube supports that extend transversely to the center axis of the heating element. The sleeve tube supports support the sleeve tube as soon as it is pushed onto the coil carrier. They hold the sleeve tube in concentric position relative to the coil carrier with the heating wire coil arranged thereon. This ensures that the heating wire coil assumes, and thereafter retains, a uniform and constant distance from the sleeve tube during the assembly and the operation of the electrical heating element.

In a preferred embodiment of the heating element according to the invention, heating wire coil mounts are arranged between the ends of the coil carrier that extend radially in relation to the center axis of the heating element. The heating wire coil mounts serve as guides during the winding of the pre-formed heating wire coil onto the coil carrier, keeping the individual coils of the heating wire coil—of which at least one coiled section comprises a multitude of helically wound courses of wire turns arranged side-by-side—laterally spaced. The heating wire coil mounts prevent short circuits between the individual turns of the heating wire coil that surround the coil carrier, with the turns of the heating wire coil being arranged on the coil carrier shell parts in a single layer. The heating wire coil mounts follow each other along a theoretical line that progresses in the form of a spiral in the longitudinal direction on the outer circumference of the coil carrier.

Preferably, in the radial direction, the heating wire coil mounts have a length that is less than half the diameter of the heating wire coil. The heating wire coil mounts guide the turns of the heating wire coil ideally up to the largest diameter of the individual wire turns of the heating wire coil. Due to the radial distance of the heating wire coil mounts from the sleeve tube, a continuous air gap is formed between the heating wire coil mounts and the interior circumference of the sleeve tube so that the air is able to pass unimpeded above the heating wire coil through the air channel and through the wire turns arranged at a distance from each other.

In a favorable variant of the invention, the coil carrier comprises a central line channel, extending in the longitudinal direction of the heating element, for a straight or coiled end section of the heating wire coil. The line channel is preferably formed by recesses of the coil carrier shell parts that extend in the longitudinal direction. When the coil carrier shell parts are positioned adjacent to each other, the individual recesses follow one another without a gap in the circumferential direction, delimiting the line channel that is open to the outside in the longitudinal direction of the heating element. The straight or coiled longitudinal section of the heating wire coil is able to enter and exit at the open ends of the line channel. The diameter of the line channel is typically smaller than the diameter of the heating wire coil and preferably approximately matches the diameter of the resistance wire of the wire turns of the heating wire coil.

Advantageously, the coil carrier shell parts are held adjacent to each other by the heating wire coil wound in a spiral around them. Additional means for fixing the coil carrier shell parts in adjacent positions are therefore not required. This permits a simple, fast, and cost-efficient assembly of the electrical heating element according to the invention.

Preferably, the heating wire coil is arranged at the smallest possible radial distance from the sleeve tube, with the distance selected so that, during the assembly of the heating element, the sleeve tube can just barely be guided over the coil carrier with the heating wire coil arranged in a spiral on its outside, without deforming the heating wire coil permanently in the radial direction. The interior diameter of the sleeve tube is therefore selected to be only slightly larger than the exterior diameter of the turns of the heating wire coil that is determined by the exterior diameter of the coil carrier. Typically, the distance of the heating wire coil from the sleeve tube is less than 1 mm, with the sleeve tube being held at an even distance from the heating wire coil by the sleeve tube supports of the coil carrier shell parts.

Preferably, the wire ends of the heating wire coil, i.e. the straight longitudinal sections of the heating wire coil, are arranged at one end of the heating element. At the end of the heating element that comprises the wire ends and is colder during operation, a metal part, preferably a metal disk, is arranged as an attachment flange that is connected to the coil carrier shell parts. The connection can be accomplished by bolts or rivets, for example. Especially in the area of the ventilation channel, the metal part may comprise air passages to the air channel of the electrical heating element.

Advantageously, the geometry of the coil carrier shell parts is selected so that the blanks for the coil carrier shell parts can be made by means of a powder molding process. Preferably, the pressing direction in the mold and the forming direction out of the mold are perpendicular to the direction of the extension of the coil carrier shell parts. This permits a simple design of the mold and of the press die, and a correspondingly short process time for the production of the molded part for the coil carrier shell parts.

Due to the novel arrangement, dimensioning, and design of the coil carrier, the heating wire coil, and the sleeve tube, a passive protection of the heating element according to the invention is achieved when the air flow through the heating element fails. In addition, cost-efficient production is possible due to the simple manufacture of the coil carrier shell parts and the low costs associated with the assembly of the coil carrier shell parts to form the coil carrier. Especially due to the absence of holes, the coil carrier shell parts can be made by simple molding instead of extrusion. The pushed-on sleeve tube also fixes the coil carrier with the heating wire coil wound around it, thereby replacing the installation of lids and covers on the coil carrier. It is another advantage of the special construction of the heating element according to the invention that no partial section of the heating wire coil is enclosed or covered by another partial section, and that the heating wire coil is placed as close as possible to the exterior wall of the heating element, i.e. to the sleeve tube. As a result, the thermal energy of the heating wire coils can be dissipated via the exterior walls by means of the air flow through the provided air channel in case of insufficient or absent cooling. Due to the novel design and arrangement, the heating element will not be destroyed by the heating wire coil burning through even when there is a build-up of heat in the air channel due to a malfunction of the stove. The electrical heating element is supplied with power, as is common, by means of a cable connection at the cold end of the electrical heating element where the attachment flange is located. For this purpose, the straight or coiled longitudinal end section of the heating wire coil passes through the interior of the coil carrier in the line channel to the cold end of the heating element.

The newly proposed heating element can be produced in a simple way by first placing the straight or coiled longitudinal end section of the heating wire coil into the recess forming the line channel of a first coil carrier shell part and then covering it with the other coil carrier shell parts. After that, the heating wire coil is wound in a spiral around the adjacent coil carrier shell parts forming the coil carrier. Then, the ends of the resistance wire of the straight longitudinal sections of the heating wire coil are connected to the connecting wires of a connecting cable, for example by means of crimping. In order to improve the mechanical stability as well as to produce greater strength in terms of overheating, the heating wire coil at its connecting ends may be secured in the coil carrier by means of a casting compound before the sleeve tube is pushed on. The last step consists of connecting the metal part, for example a metal disk that serves to fix the sleeve tube as well as a support (connection flange) in the ignition channel, to the coil carrier, for example by means of two bolts.

The electrical heating element as described above may also comprise, in addition to the heating wire, a thermal probe or a thermal switch in the line channel extending in the longitudinal direction of the heating element. By means of the thermal probe with an integrated or downstream power switch for the operating current of the heating element, overheating and therefore a possible destruction of the heating wire coil can be prevented if, for example due to contamination, no air at all flows through the heating element.

Briefly summarized, the electrical heating element and/or its specific manufacturing process offer the following advantages:

The at least two coil carrier shell parts of the coil carrier have no holes and are therefore simple to manufacture by means of molding. Due to the division of the coil carrier, it is only necessary to place the straight longitudinal section of the heating wire coil into a coil carrier shell part at the start of the assembly process, without a need for it to be pulled through the coil carrier. This makes it possible to either automate the production in a simple way or to simplify the manual production of the heating element. The arrangement of the heating wire coil and of the sleeve tube is designed so that all involved parts remain in position without a bolt or some other fixing element being necessary. Also, the coiled section of the heating wire coil maintains the same distance everywhere to the sleeve tube arranged on the outside, and is not surrounded by another coiled longitudinal section of the heating wire coil. This is important when not enough air flows transversely through the heating wire coil and the only possibility for heat dissipation from the heating wire coil is via the wall of the sleeve tube. In addition, the coil carrier has a low mass that, in conjunction with the not-enclosing arrangement of the heating wire coil relative to the coil carrier, effects quick heating of the electrical heating element.

Below, the invention is explained in detail with reference to an embodiment shown in the drawing. Additional characteristics of the invention are given in the following description of the embodiment of the invention in conjunction with the claims and the attached drawing. The individual characteristics of the invention may be realized either individually by themselves or in combinations of several in different embodiments of the invention.

### BRIEF DESCRIPTION OF THE DRAWINGS

FIG. 1 shows an electrical heating element according to the invention in a perspective view;

FIG. 2 shows the heating element from FIG. 1 without the heating wire coil that is not shown to allow an unimpeded view of the coil carrier;

FIG. 3 shows the heating element according to FIG. 1 in an axial section view;

FIG. 4 shows the heating element according to FIG. 1 in an axial section view; and

FIG. 5 shows the coil carrier of the heating element from FIG. 2 with the coil carrier shell parts taken apart.

### DETAILED DESCRIPTION OF THE INVENTION

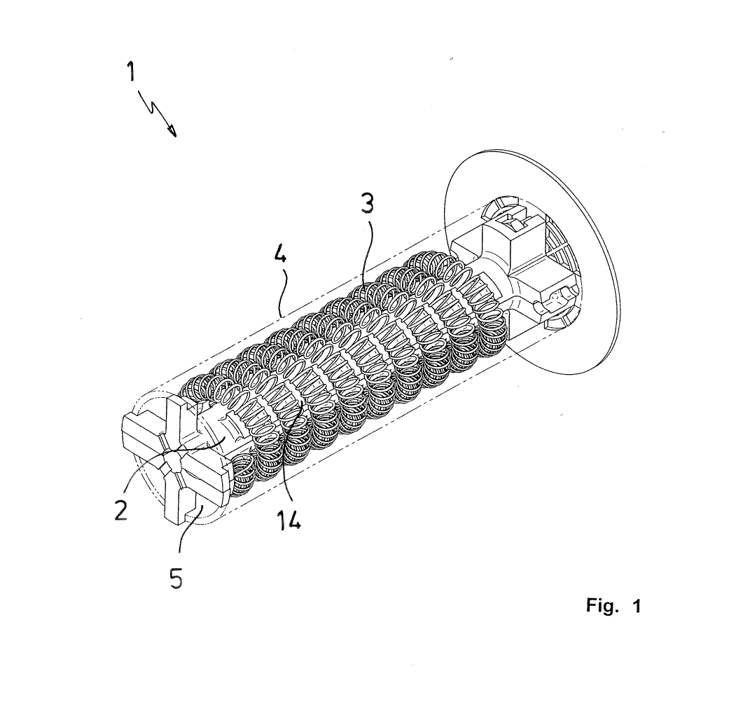

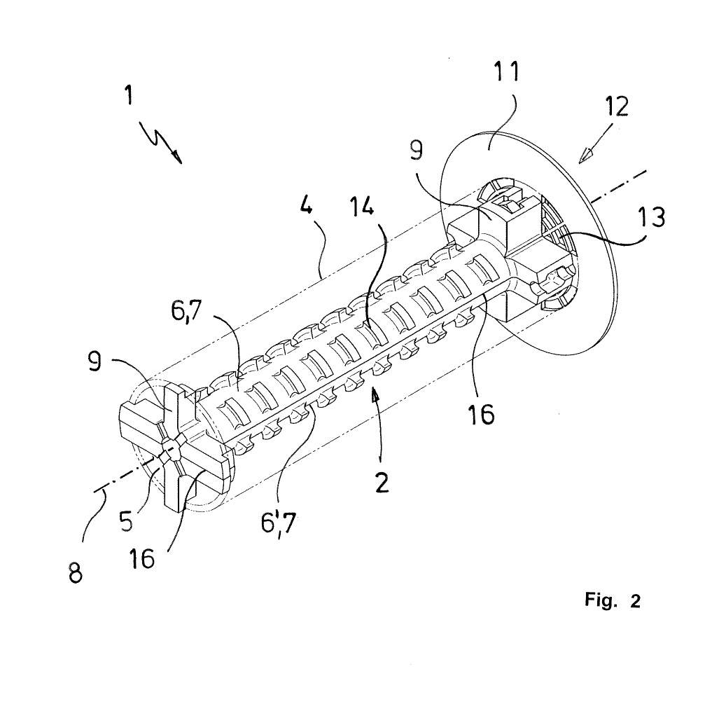

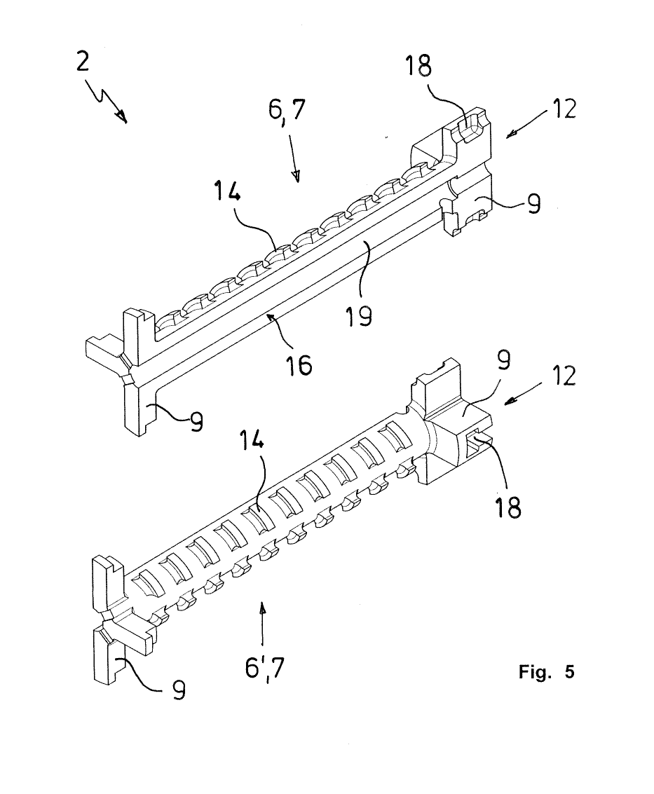

FIG. 1 shows a heating element 1 according to the invention that comprises an elongated coil carrier 2 for accepting a heating wire coil 3. The heating wire coil 3 is held by the coil carrier 2 that is made of a thermally resistant, electrically insulating material such as ceramic in a spiral-like arrangement. In FIG. 2, the heating wire coil 3 of the heating element 1 is not shown to allow an unimpeded view of the coil carrier 2. The heating wire coil 3 is enclosed by a sleeve tube 4 that is also made of a thermally resistant material. The coil carrier 2 and the sleeve tube 4 delimit an air channel 5 of the electrical heating element through which the heating wire coil 3 passes in the longitudinal direction and that extends over the entire axial length of the heating element 1. The coil carrier 2 is composed of two coil carrier shell parts 6, 6′. For the purpose of illustration, FIG. 5 shows the coil carrier 2 by itself in a perspective view with the coil carrier shell parts 6, 6′ separated from each other.

As coil carrier half shells 7, the coil carrier shell parts 6, 6′ are identical and are arranged symmetrically to a center axis 8 of the heating element 1. At the two face sides of the coil carrier 2, the two coil carrier half shells 7 forming the coil carrier 2 have several sleeve tube supports 9 extending transversely to the center axis 8 of the heating element 1 that are molded onto the coil carrier shell parts 6, 6′. They support the sleeve tube 4 on an interior circumferential surface 10. In conjunction with a metal part 11 in the form of a metal plate 11 that is arranged at that end 12 of the coil carrier 2 and of the sleeve tube 4 that is colder during operation, the sleeve tube supports 9 support the sleeve tube 4 in the radial as well as the axial direction of the heating element 1. At the same time, the metal plate 11 serves as attachment flange for the heating element 1 on a heating furnace stove (not shown in the drawing). In the area of the air channel 5, the metal plate 11 has a number of air passages 13.

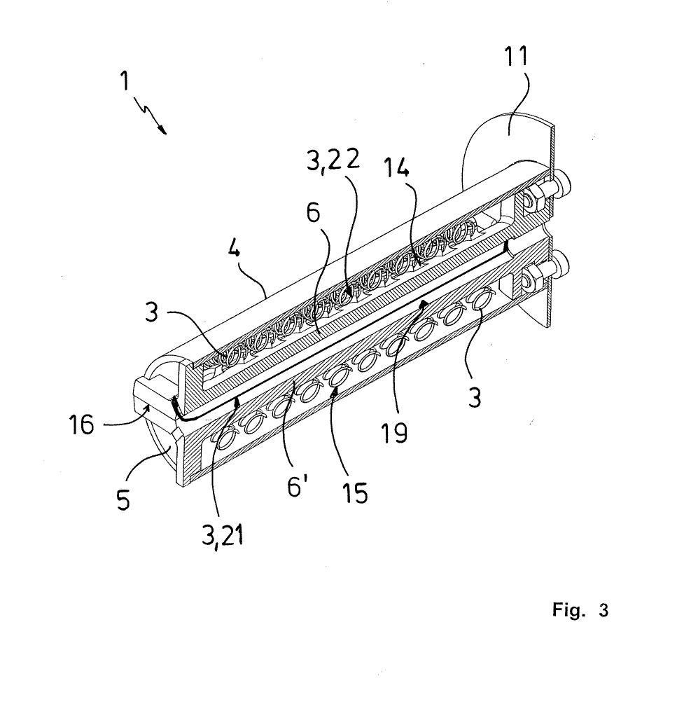

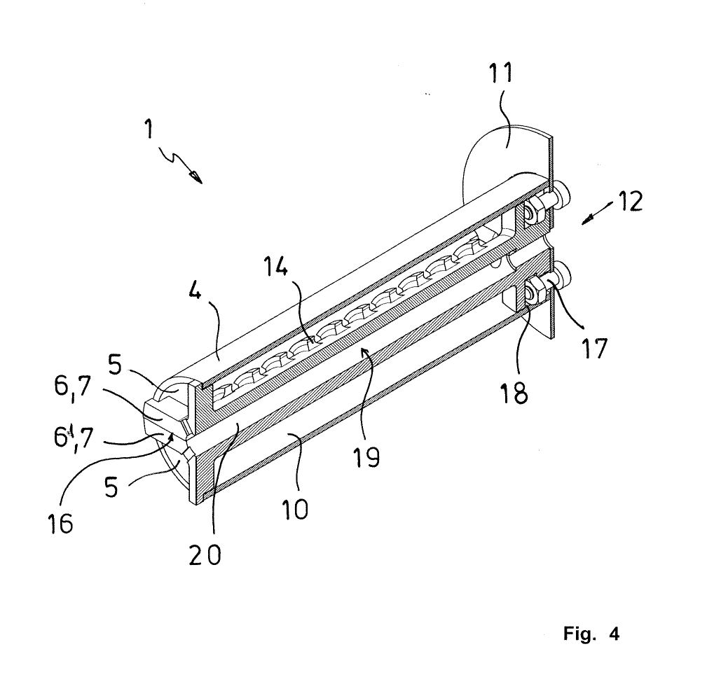

The FIGS. 3, 4 both show an axial section view of the heating element 1 shown in the FIGS. 1, 2, with the coil carrier 2 shown in FIG. 3 with the heating wire coil 3 and in FIG. 4 without the heating wire coil 3. In the longitudinal direction of the heating element 1, between the sleeve tube supports 9 of the coil carrier half shells 7, heating wire coil mounts 14 are arranged that extend radially in relation to the center axis 8 of the heating element 1. In the radial direction of the coil carrier half shells 7, the heating wire coil mounts 14 have a length that is approximately equal to half the diameter of the heating wire coil 3, and they fix the windings 15 of the heating wire coil 3 in the axial direction on the coil carrier half shells 7. The heating wire coil 3 is arranged at a small radial distance from the sleeve tube 4, so that hardly an air gap exists between the heating wire coil 3 and the interior circumferential surface 10 of the sleeve tube 4. The coil carrier half shells 7 are located adjacent to each other at a separation plane 16 of the coil carrier 2. In FIG. 2, the electrical heating element according to the invention is shown in a section perpendicular to the separation plane 16. In addition, FIG. 2 shows that the metal disk 11 is fixed on the coil carrier 2 by means of the bolts 17 that engage receiving chambers 18 of the coil carrier shell parts 6, 6′.

FIG. 5 shows the coil carrier 2 without the heating wire coil 3, with the coil carrier half shells 7 separated from each other. Each of the two coil carrier half shells 7 has a recess 19 extending in the longitudinal direction that, together with a corresponding recess 19 of the opposite coil carrier half shell 7, forms a line channel 20 for a straight longitudinal section 21 of the heating wire coil 3. The straight longitudinal section 21 follows the coiled central longitudinal section 22 of the heating wire coil 3 that surrounds the coil carrier 2 in a spiral and is arranged opposite the sleeve tube 4.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. An electrical heating element, preferably for the ignition of a biomass heating system such as pellet stoves, with an elongated coil carrier made of a thermally resistant, electrically insulating material and designed to accept a heating wire coil, where the heating wire coil is held spiral-like on the outside the coil carrier and is enclosed by a sleeve tube made of a thermally resistant material, and where the coil carrier and the sleeve tube delimit an air channel through which the heating wire coil passes, wherein the coil carrier comprises at least two adjacent coil carrier shell parts that extend symmetrically to the center axis of the heating element in the longitudinal direction of the coil carrier.

2. The electrical heating element according to claim 1, wherein the coil carrier shell parts are of identical design.

3. The electrical heating element according to claim 1, wherein at least at the two ends, at least two coil carrier shell parts comprise sleeve tube supports extending transversely to the center axis of the heating element.

4. The electrical heating element according to claim 1, wherein in the longitudinal direction of the heating element between the coil carrier ends, heating wire coil mounts are arranged that extend radially to the center axis of the heating element.

5. The electrical heating element according to claim 4, wherein in the radial direction, the heating wire coil mounts have a length that is smaller than half the diameter of the heating wire coil.

6. The electrical heating element according to claim 1, wherein, extending in the longitudinal direction of the heating element, the coil carrier comprises a central line channel for a straight or coiled longitudinal section of the heating wire coil located at the end thereof.

7. The electrical heating element according to claim 6, wherein the line channel is formed by recesses of the coil carrier shell parts that extend in the longitudinal direction.

8. The electrical heating element according to claim 1, wherein the coil carrier shell parts are held adjacent to each other by the heating wire coil.

9. The electrical heating element according to claim 1, wherein the heating wire coil is arranged at a minimum radial distance from the sleeve tube.

10. The electrical heating element according to claim 1, wherein the wire ends of the heating wire coil are located at an end of the heating element at which a metal part is connected as attachment flange to the coil carrier shell parts.

11. The electrical heating element according to claim 10, wherein the metal part has air passages in the area of the air channel.

12. The electrical heating element according to claim 1, wherein the material of the coil carrier shell parts is ceramic.

13. The electrical heating element according to claim 12, wherein the geometry of the coil carrier shell parts is designed to make it possible for the blanks for the coil carrier shell parts to be made by means of a pressing process.

14. The electrical heating element according to claim 1, wherein the sleeve tube is a mica tube or a ceramic tube.

15. The electrical heating element according to claim 1, wherein the coil carrier shell parts are designed as coil carrier half shells.

16. The electrical heating element according to claim 1, wherein in addition to the heating wire, a thermal probe or a thermal switch is arranged in the line channel extending in the longitudinal direction of the heating element.
